(19) United States
(12) Patent Application Publication
(10) Pub. No.: US 2010/0033329 A1
(43) Pub. Date: Feb. 11, 2010

(54) Portable Security Container with Movement Detection System

(75) Inventors: Barrie William Davis, South Brisbane (AU); Benjamin John Davis, Fortitude Valley (AU); Matthew Kai Davis, Fortitude Valley (AU)

Correspondence Address: FULBRIGHT & JAWORSKI L.L.P., 600 CONGRESS AVE., SUITE 2400, AUSTIN, TX, 78701, US

(73) Assignee: XITEL PTY. LTD., South Brisbane (AU)

(21) Appl. No.: 12/536,902

(22) Filed: Aug. 6, 2009

Related U.S. Application Data
(60) Provisional application No. 61/087,175, filed on Aug. 8, 2008.

(51) Int. Cl. G08B 13/14; G08B 21/00

(52) U.S. Cl. 340/571; 340/686.6

(57) ABSTRACT

A device and method for protecting personal property. The device includes a movement detection system and an alarm adapted to signal when the device has moved beyond a predetermined position from a reference point.

### CROSS-REFERENCE TO RELATED APPLICATIONS

This application claims the benefit of U.S. Provisional Application No. 61/087,175 filed Aug. 8, 2008, entitled “Portable Security Container With Movement Detection System,” the entire contents of which is incorporated by reference herein.

### FIELD OF THE INVENTION

The present invention relates to improvements in devices designed to protect personal portable property such as mobile phones, music players, keys, wallets, purses, laptop computers, guns and other similar personal items which can be quickly and easily stolen.

### BACKGROUND OF THE INVENTION

In recent times the value of personal belongings carried by most people in their day to day business has increased significantly. As well as the replacement cost of devices such as mobile phones, music players etc., there is also the additional cost of losing or having to replace phone numbers, photographs, music etc., which are held in the portable devices. Most people understand that having one of these devices stolen or misplaced will be a significant inconvenience in addition to the financial cost of buying a replacement. In the case of a laptop computer or other device capable of storing personal data, the replacement cost of the device may be insignificant compared to the value of the information saved therein.

In addition to the personal electronic devices, loss of other more fundamental items people carry on their person such as house keys, car keys, wallets, credit cards, passports, etc., can have a significant impact if they are stolen.

One way to protect these personal items is to place them in a secure environment. However on many occasions this is not possible. At the beach, gymnasium, living in a dormitory, or even just leaving a work space for a short time, exposes personal property to theft. Lockers, desk drawers, cupboards etc. provide some protection, but in most cases can be easily forced open or defeated in some other manner. When this happens, there is no alarm event to alert others the theft is occurring, which is why the loss of personal property in these situations is so prevalent.

Recent statistics indicate that of the total university dormitory population of the USA, about 25% will experience one personal theft a year. When extrapolated across the country to include country clubs, sports facilities, factory/office locker rooms, office desks etc., the level of personal theft is high and increasing. This is especially so for personal electronic devices which are now so wide spread that it is almost impossible to identify a specific unit as one's own once it has been stolen.

There are any number of devices which will detect the occurrence of motion and provide an alarm when they are moved. Most, if not all of these devices rely on the detection of motion in some way or another. They commonly rely on the motion of an attached object to cause a mechanical motion of part of the device which is then detected and an alert provided. Examples are mercury switch relays, moving pin mechanisms and ball race devices where the movement of an object causes a secondary motion within the detection device, which causes an alarm event.

A problem in detecting the motion of an object as the necessary event to cause an alarm condition is that motion in itself is not necessarily a sufficient condition for an alarm event. For example, if an object is accidentally knocked, it will experience motion even though it may not be subject to movement which involves the change in the position or location of something. If the movement of an object is to be the cause for an alarm event, then this condition may be accidentally satisfied and result in a false alarm if only the occurrence of motion is recognized.

### SUMMARY OF THE INVENTION

In one preferred aspect, the present invention is a portable light weight container which can be locked by means of a combination lock to secure any items placed inside. To prevent the locked container from being moved to a location where it could be forced open without attracting attention, a movement detection, or displacement measuring system is incorporated into the lid of the container. An audible alarm is also provided so that when the container is moved a predetermined distance in any three dimensional direction from an initial reference position, the alarm is activated.

In a preferred aspect, the present invention is able to determine if it is being moved and measure (calculate) the distance and direction (displacement) it has traveled in three dimensional space from its reference position since the movement commenced. In addition, the present invention in a preferred aspect may be adapted to determine if the displacement exceeds a specified value or set of parameters to the extent that a hostile event has occurred, in which case the audible alarm is sounded.

In another preferred aspect the present invention is able to determine if it is being moved and/or tilted and may be adapted to determine if the movement and/or tilt is a hostile event in which case an audible alarm is sounded.

The present invention preferably provides protection against the theft of personal valuable items in several ways which work in unison to provide a comprehensive theft prevention method.

### BRIEF DESCRIPTION OF THE FIGURES

FIG. 1 is a perspective view of a security container with movement detection system in accordance with a preferred embodiment of the present invention.

FIG. 2 is an exploded view of the container of FIG. 1.

FIG. 3 is an enlarged view of the movement detection system of the container of FIG. 1.

FIG. 4 is a diagram of the movement detection system of FIG. 3.

FIG. 5 is a perspective view of a portable alarm system in accordance with another preferred embodiment of the present invention.

FIG. 6 is an exploded view of the alarm system of FIG. 5.

FIG. 7 is a perspective view of the movement detection system in accordance with another preferred embodiment of the present invention, sized to be able to contain a laptop computer.

### DETAILED DESCRIPTION OF ILLUSTRATIVE EMBODIMENTS

Alternative embodiments of the invention will be apparent to those skilled in the art from consideration of the specification and practice of the invention disclosed herein. It is intended that the specification and examples be considered as exemplary only, with a true scope and spirit of the invention being indicated by the claims which follow.

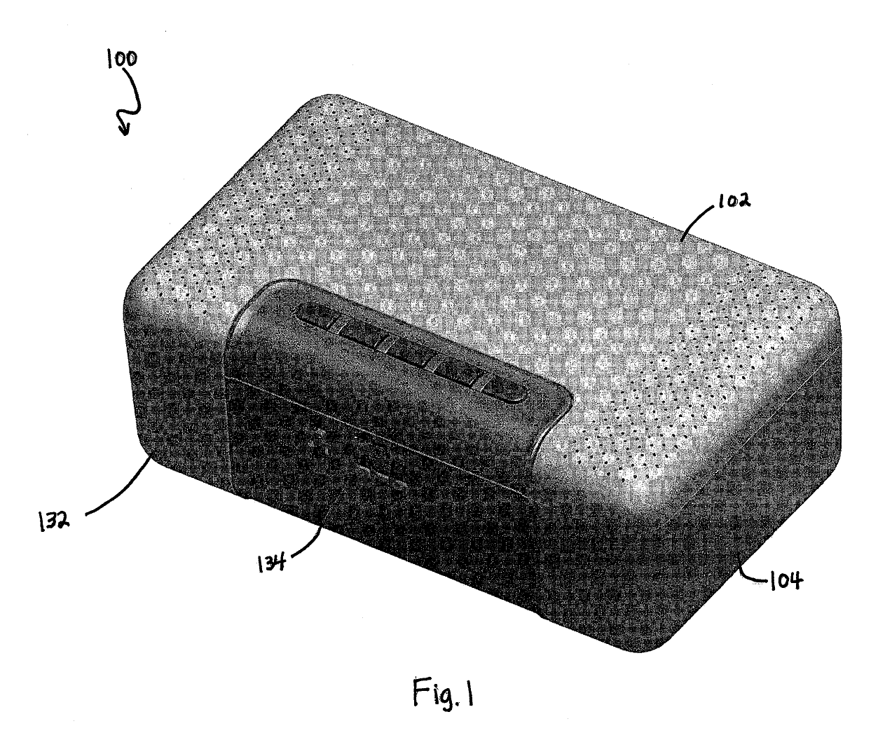

FIGS. 1 to 4 show a preferred embodiment of a security container 100 having a lid 102, a base 104 and a movement detection system 106. The preferred elements of container 100 and their interrelationship are described below.

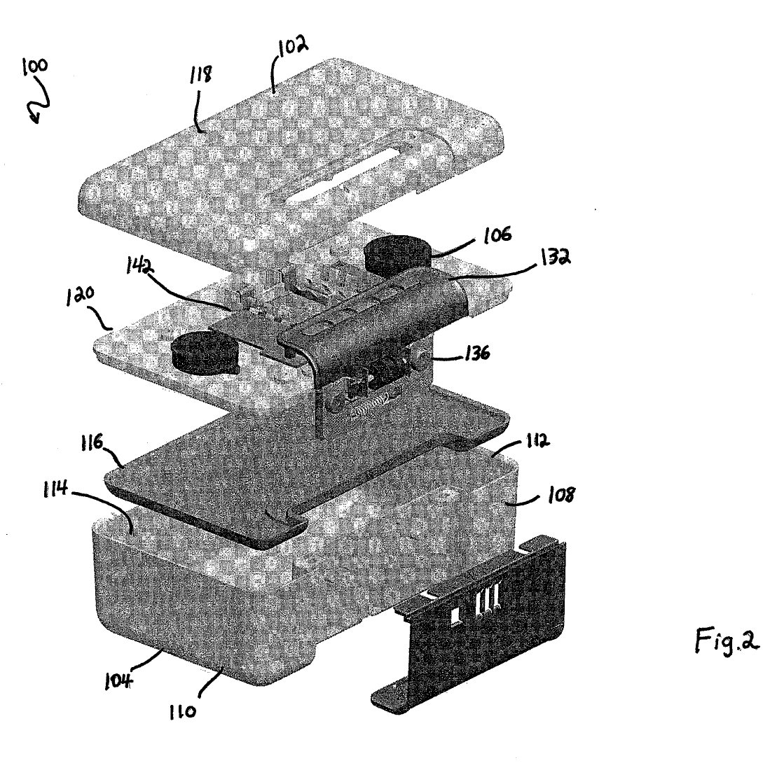

Referring to FIGS. 1 and 2, container 100 includes a front 108, sides 110, 112 and an interior 114. Interior 114 preferably is sized and configured to receive a removable bottom tray 116. As shown in FIG. 2, lid 102 preferably includes a top cover 118 and a base cover 120 on which is at least a portion of movement detection system 106.

As shown in FIGS. 2 to 4, movement detection system 106 preferably includes an electronics assembly having a motion detector 122, a controller 124, an alarm 126 and an arming mechanism 128. Each of these components are discussed in further detail below.

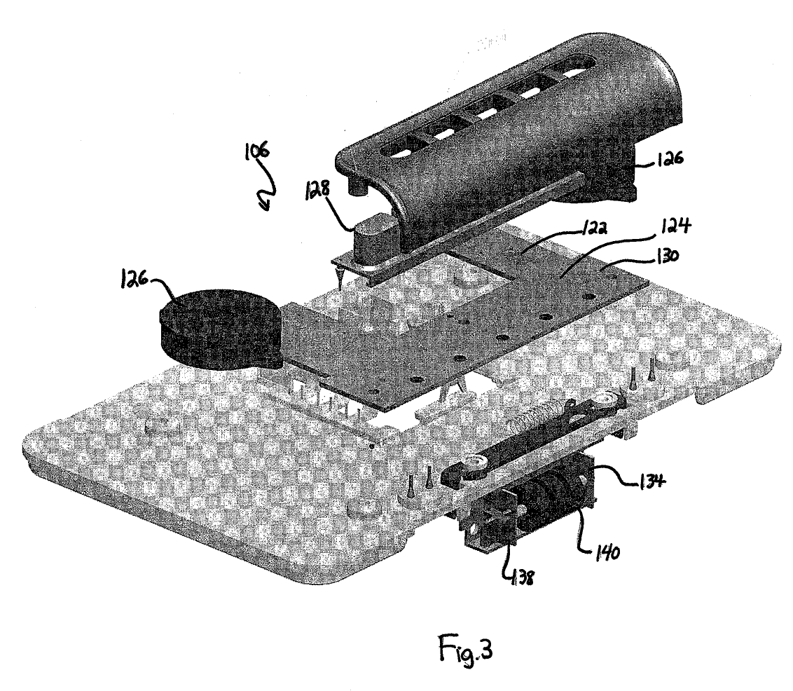

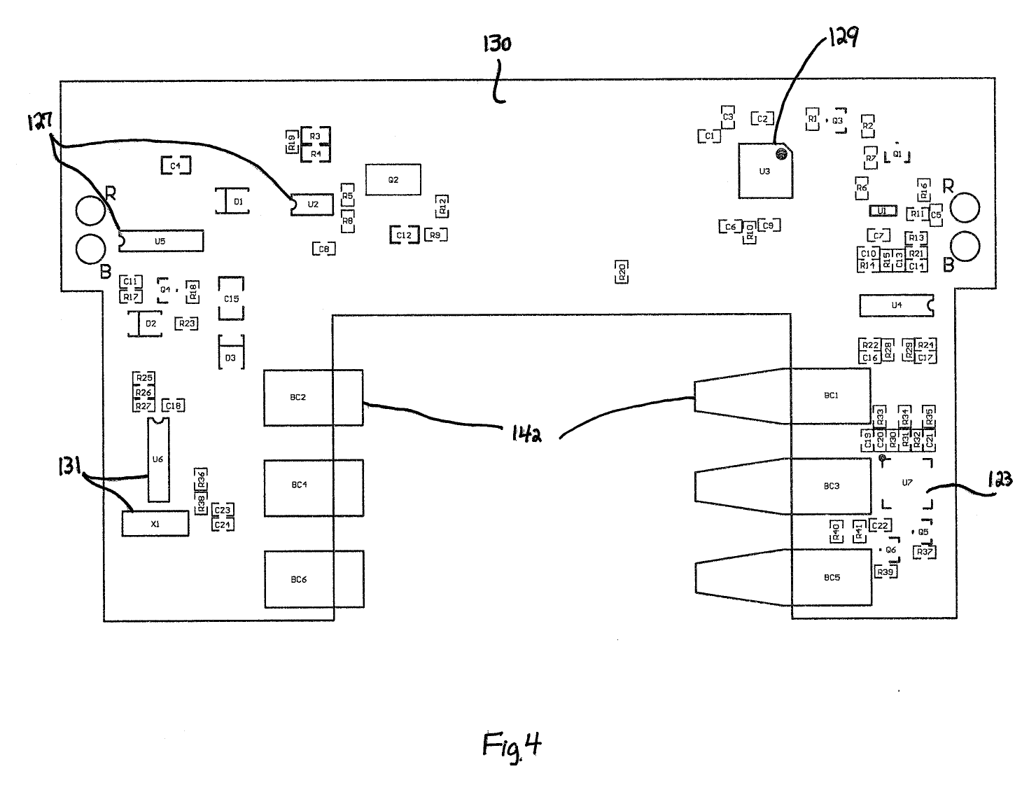

Referring to FIGS. 3 and 4, motion detector 122 is preferably formed as an accelerometer 123. The accelerometer is preferably a MEMS three-axis, low gravity analogue output acceleration sensor which provides its own instantaneous acceleration relative to the acceleration of the earth's gravity of 1 g, the acceleration when the accelerometer is at rest. The outputs of the accelerometer are preferably three analogue signals, one each for the individual acceleration relative to the earth's gravity in the X axis, Y axis and Z axis coordinates of three dimensional space.

Referring to FIGS. 3 and 4, the accelerometer 123 may also be a MEMS three-axis low gravity digital output acceleration sensor which provides its own instantaneous acceleration relative to the earth's gravity of 1 g, the acceleration of the accelerometer at rest. The digital output of the accelerometer may be one of several standard serial protocols such as the PC or SPI synchronous serial digital communications methods. The associated protocol format allows the accelerometer to be controlled by a controller 124 allowing the individual accelerations relative to earth's gravity in the X axis, Y axis and Z axis coordinates of three dimensional space to be accessed.

When accelerometer 123 is at rest and one axis is aligned with the centre of the earth, the analogue signal for that axis will represent 1 g, the acceleration due to the earth's gravity. The analogue signal outputs for the other two axes will be zero. When accelerometer 123 does not have an axis aligned with the centre of the earth, each axis output will have a non-zero analogue signal output which will again represent the acceleration due to the earth's gravity of 1 g. When accelerometer 123 is moved, the analogue signal outputs preferably change from the “at rest” values and will represent the acceleration of the accelerometer as it moves through three dimensional space relative to the “at rest” values which represent the earth's acceleration of 1 g.

The system may include a gyroscope if desired. Incorporation of a gyroscope allows the angular momentum in terms of the container's pitch, and/or roll and/or yaw to be determined which can be used to enhance the accuracy when determining the position of the container. The system may include a magnetometer if desired. Incorporation of a magnetometer allows the direction and magnitude of the earth's magnetic field to be determined which can be used to enhance the accuracy when determining the position of the container.

Referring to FIGS. 3 and 4, controller 124 is preferably formed as a single chip microcontroller 129 having a printed circuit board 130, although a multiple chip microcontroller can equally be used if desired. Microcontroller 129 receives the acceleration information in analogue format from accelerometer 123 via the X axis, Y axis and Z axis signal outputs of the accelerometer. Because the value of the acceleration is preferably represented as three electrical analogue voltages, it is usually necessary to convert the analogue signal value to a digital value to allow the acceleration information to be processed by the mathematical algorithms executed by microcontroller 129. Preferably the microcontroller incorporates an Analogue to Digital (A/D) conversion functional unit, although an external A/D could also be used. It is envisaged that the A/D function may form a portion of the accelerometer if desired. It will be appreciated that accelerometer 123 may provide values in digital format and that microcontroller 129 may have a digital chip to eliminate any need for an A/D conversion.

Microcontroller 129 preferably includes a real time clock 131. Basic physics teaches us that acceleration a is the first derivative of velocity v(t) with respect to time and the second derivative of displacement s(t) with respect to time thus the basic equations are:

$$a = \frac{d v}{d t} v = \frac{d s}{d t} a = \frac{d ( ds )}{d {t}^{2}}$$

It can be seen that knowing the value of acceleration a and having a means to measure time accurately, it is possible to determine velocity v which, is the integral with respect to time of acceleration a and determine displacement s which is the integral with respect to time of velocity v thus the basic equations are:

ν=∫(α)dt s=∫(ν)dt s=∫(∫(α)dt)dt

By using a three-axis accelerometer, the controller's microcontroller mathematical algorithms calculate the relationships between acceleration a, velocity v and displacement s for the x, y and z axis to determine the movement and position (displacement) in three dimensional space relative to an “at rest” or reference position prior to the movement of container 100 commencing.

Microcontroller 129 preferably has a non-volatile, read-only memory that provides the program storage for the mathematical, logical and decision making algorithms. Microcontroller 129 preferably has a volatile, non-flash read-write memory that provides temporary storage for the results of calculations. Microcontroller 129 preferably has an interrupt system which may be used by the real time clock and an input means, described further below, to activate the movement detection system if it is in a power down or sleep mode.

Real time clock 131 is preferably an independent timing circuit which can be started and stopped by microcontroller 129. It is preferably connected to the microcontroller's interrupt system and is used by microcontroller 129 to provide a “wake up” signal when in a sleep mode. To conserve battery power, microcontroller 129 can activate real time clock 131 and then change to its sleep mode. At a predetermined time, real time clock 131 will activate the microcontroller's interrupt system and cause microcontroller 129 to “wake up” to monitor mode to check the status of the movement detection system.

Referring to FIG. 3, alarm 126 is preferably an audible alarm, more preferably a piezo audio transducer unit which can provide in excess of 80 dB of audible sound from a physically small, low power device. The audible alarm may be used in conjunction with an LED indicator to provide audio and visual feedback to the user on the status of system 106 during the entry of the security code and the arming and disarming operations, described further below. The piezo audio transducer is preferably driven by a switching H-bridge amplifier which provides an optimum 30 volts peak-peak signal from a 15 volt power supply derived from a primary 4.5 volt battery power system. It will be appreciated that the piezo audio transducer can also be driven from an auto transformer to provide the required voltage. Alarm 126 is preferably driven by drivers 127 (FIG. 4).

It will be appreciated that the real time clock 131 can be incorporated into the microcontroller 129, but this method may consume additional battery power to the external real time clock method.

As shown in FIGS. 1 and 2, arming mechanism 128 preferably includes a keypad 132 having preferably five keys as the interface between a user and the microcontroller. Keypad 132 is preferably used to: arm the system; disarm the system; and reset the system if a mistake is made when entering a user command.

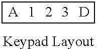

As shown above, keypad 132 preferably includes five keys or buttons in one row. The keys are preferably annotated A (Arm), the numbers one (1), two (2), and three (3) and D (Disarm). The five keys are preferably used in conjunction with each other to: select a motion sensitivity program; enter the security code; arm the system which activates movement detection; disarm the system which suspends movement detection.

The preferred functions of the individual keys are: number keys 1, 2, and 3—used to enter a four to six number security code into the system; Alpha key A—the first and last character of an arm sequence; and Alpha key D—the first and last character of a disarm sequence. It will be appreciated that the keys may be differently configured if desired. For example, instead of “A” and “D” keys, symbols showing a padlock in the locked or unlocked position may be used as desired.

Keypad 132 preferably connects directly to the microcontroller interrupt system and pressing the arm or disarm key preferably causes the microcontroller to power up from sleep mode and bring system 106 into a monitor mode, its active mode of operation.

As shown in FIGS. 2 and 3, container 100 preferably includes a lock 134, which is preferably a combination lock. Lock 134 preferably includes a mounting boss and lock plate slide guide 136, a lock plate knob 138 and a combination element 140. The combination lock is preferably a three-rotor mechanism with each rotor preferably having ten positions, which provide an adequate number of unique settings to thwart most attempts to guess the correct combination. Other combinations of rotors and rotor positions can be used if required. Alternatively, a mechanical lock and key can be used instead of a combination lock.

Referring to FIG. 2, movement detection system 106 is preferably powered by batteries insertable into battery clips 142. The piezo audio alarm provides its loudest audio output when it is driven by a 30 volt peak-peak signal while the rest of the electronics circuits require from 3 to 5 volts DC. Primary power is preferably provided by three AAA batteries, preferably the Alkaline type, which when connected in series, provide a terminal voltage of approximately 4.5 volts fully charged. The batteries preferably provide the power to the low voltage electronic circuits directly through electronic series regulators. The relative high voltage 15 volt power supply for the piezo audio alarm is derived from the batteries preferably by means of a DC/DC convertor which is only activated when the alarm is operating. At all other times it is preferably deactivated to conserve battery power.

Container 100 may be constructed from a variety of materials. For example only, the body of container 100 may made of high impact resistant plastic (ABS, PC or other similar materials) or metal and is preferably relatively light weight. The container may be formed from a flexible material such as a cloth or soft sleeve if desired. A cloth material is more light-weight than many other materials. The cloth material may include one or more fibres of a material more resistant to breakage than the cloth to permit the cloth sleeve to be substantially tamper-proof when attacked by a sharp object such as a knife. For example, the cloth may include one or more ceramic or metal fibres interwoven into fabric.

Having described the preferred components of the security container, a preferred method of use will now be described with reference to FIGS. 1 to 4.

To initialize movement detection system 106, preferably a user security code is entered. Once the security code has been accepted, preferably the same four to six digit numeric sequence may be used to arm or disarm the system. To initialize the system, the user preferably presses and holds the arm and disarm keys at the same time until the monitor light turns on. The old code is entered and then the user presses the disarm key. The system will beep once and the monitor light will start flashing. The new 4 to 6 digit code is entered and the user presses the arm key. The system will beep twice. The user enters the new 4 to 6 digit code again and presses the arm key. The system will beep twice and the monitor light will stop flashing. This indicates that the new code has been saved into memory.

If the system beeps one long beep and the monitor light stops flashing, it means an entry error has been detected and the complete security code sequence needs to be started again by releasing and then pressing and holding the arm and disarm keys down at the same time to begin another security code initialisation sequence.

The user can reset the security code at any time the system is disarmed by holding the arm and disarm keys down at the same time and then repeating the initialization procedure. Once the security code has been entered and accepted the system can be armed and disarmed as required by the user.

The distance that container 100 may be moved from an initial reference point before alarm 126 is activated may be entered via keypad 132 prior to arming the system. The user can change the allowable movement distance, or alarm sphere, from zero to effectively any distance desired. The distance may be entered in either Metric or Imperial measurement systems provide flexibility for the user. Controller 124 may be configured to permit the user to select from a number of different pre-set distances rather than discretely entering a specific distance.

The allowable distance setting can be changed at any time and is retained once set until it is changed again by the user. This allows a single system to be used for multiple applications. For example, at the zero distance setting, the movement detection system could be used to monitor the movement of a motel door while later in the same day, a distance setting of 3 feet or 90 cm could be used to protect a container at a trade show while still allowing access to it.

To arm the system, the user preferably presses the arm key followed by the security code's four to six digit numeric sequence and then presses the arm key a second time to complete the arm function. As soon as the arm key is pressed, microcontroller 129 changes from sleep mode to monitor mode and monitors keypad 132 for the entry of the arm sequence. If an incorrect security code is entered or the user takes longer than the guard time to enter the arm sequence, a long beep is given and the arm function is terminated. At any time before the arm key is pressed a second time, the arm sequence can be terminated by pressing the disarm key. The system will respond with a long beep indicating it has recognized the termination of the arm sequence. Alternatively, if the arm sequence is discontinued, microcontroller 129 will preferably automatically terminate the arm sequence when the guard time expires.

When the arm key is pressed to initiate an arm sequence, the LED indicator is illuminated and remains on for the duration of the arm sequence.

If the arm sequence is accepted, the system gives two short beeps indicating the transition delay has commenced, which allows the user to position container 100 before monitoring begins. The system gives a short beep for each second of the transition delay interval and the LED indicator changes from being continuously illuminated to flashing in unison with each beep. When the transition delay expires, the system gives another two short beeps before becoming armed, the LED indicator is turned off and the system enters its monitor mode.

Once system 106 is armed, it enters a monitor mode and preferably any movement is deemed to be a hostile event capable of activating alarm 126. If the system is already armed and a user starts to enter the arm sequence again, the system is preferably programmed to recognize this and suspend activation of the alarm pending a correct arming sequence being entered. If the correct arming sequence is entered, the system waits for a predetermined period of time before rearming. However, if the arming sequence is entered incorrectly, this is immediately deemed to be a hostile event. The system goes to an alarm mode and audible alarm 126 is activated.

Once system 106 has been armed, it changes from sleep mode to monitor mode where it is preferably continually checking to see if it has been moved from the initial reference point.

If lid 102 is positioned so that keypad 132 can be operated without moving container 100, the disarm sequence is similar to the arm sequence. In this situation, the user preferably presses the disarm key followed by the security code's four to six numeric sequence and then presses the disarm key a second time to complete the disarm function. If the disarm sequence is entered correctly, two short beeps are given after the disarm key is pressed the second time to complete the disarm sequence entry. The system then preferably reverts to sleep mode where the microcontroller powers the system down to its minimum operating power condition.

If the disarm sequence is not correct or takes longer than the guard time to enter, the system changes from monitor mode to a tamper mode. The disarming procedure required once the system is in tamper mode is described below.

System 106 preferably enters a tamper mode from the monitor mode when an incorrect arm or disarm sequence is entered. When the system is in tamper mode, it continues to check if it has been moved from the initial reference point. If the movement exceeds the distance and direction set by the alarm sphere, the system will enter an alarm mode.

When system 106 enters tamper mode, it will preferably only allow one more attempt for the correct disarm sequence to be entered. If the second keypad entry is a correct disarm sequence, the system will revert to sleep mode. If the second keypad entry is an incorrect disarm sequence, or an incorrect arm sequence, the system will change to alarm mode. If the second keypad entry is a correct arm sequence, the system will preferably wait the transition delay and then change to monitor mode.

To disarm system 106, it may be necessary for the user to move lid 102 so that they can access keypad 132. If this movement exceeds the limits set by the alarm sphere, it is interpreted by the microcontroller of controller 124 as a hostile event and system 106 will preferably immediately change from monitor mode to alarm mode. The disarm procedure required once system 106 is in alarm mode is described below.

If system 106 is to be disarmed while in monitor mode, it is possible that movement of the container will not cause a hostile event. This situation may occur when the distance the container can be moved before a hostile event happens is greater than the small distance the container moves when the disarm code is entered.

To prevent repeated attempts to disarm the system from occurring when the system is in monitor mode, controller 124 preferably automatically interprets a keypad entry as a potential hostile event. If the first number entered is correct, the microcontroller reverts to the normal disarm mode. If the first number entered is incorrect, instead of entering the alarm mode as for disarming after a hostile event, the time allowed for the sequence to be reset and then entered correctly is shortened. If the correct disarm sequence cannot be entered within the time allowed or more than three incorrect attempts are made, system 106 preferably reverts to the alarm mode and alarm 126 is activated. The incorrect entry of the disarm sequence once a keypad entry commences is preferably a sufficient condition to cause a hostile event even though the system distance limits have not been reached.

When system 106 determines that container 100 has moved beyond the pre-determined allowable distance and/or direction limits (or the alarm sphere), the system preferably registers the occurrence of a hostile event. However, the hostile event could be the result of the user moving the container in order to disarm it in the normal method of use.

Once system 106 is in alarm mode, preferably the only way to disarm the system and cancel the alarm is to reset the disarm code entry sequence and then enter the correct disarm code within a predetermined time. The number of attempts to enter the disarm code is not limited, however once the alarm condition is activated, alarm 126 will continue until the correct disarm code is entered or some other optional preset condition is satisfied.

If the alarm is cancelled with the correct disarm code, system 106 may be programmed to revert to a system idle mode. If the alarm is cancelled because another optional preset condition has been satisfied, the system will preferably revert to the arm mode.

System 106 preferably only changes to alarm mode if a hostile event is deemed to have occurred. As soon as the system enters alarm mode, it activates audible alarm 126 to alert the user and/or others that the container is being tampered with, or that the container has been moved from the initial reference point to a point beyond the alarm sphere. Movement caused by an accidental bump or knock to the system is preferably normally not deemed to be a hostile event because the movement is of very short duration and, in most cases, will not move outside of the alarm sphere.

Once system 106 is in alarm mode, it will preferably continue to activate audible alarm 126 until the correct disarm sequence is entered, movement ceases or the duration of the alarm exceeds one of the pre-set limits of the system.

System 106 is preferably able to accurately measure its own movement in the spherical coordinate system (X, Y and Z axes) relative to the initial reference point to determine if container 100 has been moved beyond preset, three dimensional limits defined by the alarm sphere. Once system 106 is in the alarm mode, its movement measuring capability in three dimensions preferably allows the system to discriminate between different hostile events and take the appropriate action relative to each event. Examples of such events include, but are not limited to: (1) the container is moving; the alarm remains active as long as the container is being moved; (2) the container has stopped moving and its position is within the alarm sphere; the alarm remains active for 30 seconds after the movement ceases; and/or (3) the container has stopped moving and its position is outside the alarm sphere; the alarm remains active until the correct disarm sequence is entered or the alarm duration exceeds preset condition.

Once system 106 enters the alarm mode, it preferably remains there until a correct disarm sequence is entered. When the system is in the alarm mode, preferably any movement of the system is measured relative to the initial reference position and is cumulative so the action taken in response to a hostile event can change as a limit is exceeded. This means that the system preferably cannot be moved in a large distance using a number of small movements. If the position of the container is within the alarm sphere after each movement, alarm 126 will cease 30 seconds after the movement ceases. However, once the position of the container exceeds the alarm sphere, irrespective of the number of movements of the container from the initial reference point, alarm 126 will preferably sound continuously.

Controller 124 may be programmed so that when the user first powers the system, the allowable movement distance is set to zero. At the zero distance setting, any motion of the container will cause an alarm condition. However, discrimination algorithms in the programming of the microcontroller may be used to determine if motion at the zero distance setting is due to an impulse occurrence, such as a knock or bump, or due to actual movement of the container from its resting position. Such algorithms may be used to allow the microcontroller to minimise false alarm conditions when a zero distance alarm setting is used.

If container 100 remains stationary, the three signal outputs of the accelerometer will show the system is being subjected to an acceleration of 1 g. A force needs to be applied to the container to move it. As soon as this occurs, the accelerometer signals will change and the microcontroller of controller 124 will determine that motion of the container is occurring.

In most applications for the container, the direction the container has moved is of little consequence. However, depending on the scope and accuracy of the application, by also incorporating a MEMS gyroscope and/or magnetometer in addition to the accelerometer which measures the acceleration of the container in the X, Y and Z axes, there is sufficient information to determine movement of the container in distance and direction in a surrounding spherical space relative to the stationary position of the container.

This capability has application where the hostile event may be determined when the container has moved in a particular direction and distance rather than just a particular distance. For example, the system could be set to allow movement in the X or Y axial direction, but not in the Z axial direction relative to the stationary position of the container. This would allow the container to be moved horizontally without an alarm condition occurring. Once the container is moved vertically (i.e., picked up), a hostile event would be registered and alarm 126 activated.

In other applications for the container, the distance the container has moved is of little consequence and that the container has moved at all is sufficient to determine a hostile event has occurred.

In this aspect, an allowable acceleration is set and if the acceleration of the container in the X axis, Y axis or Z axis individually or combined exceeds a threshold value, a hostile event is determined.

To discriminate between accidental movements or bumps and movements which are due to a hostile event, the duration that the acceleration of the container exceeds the threshold value may be used as a second and necessary condition to determine a hostile event has occurred. In this case an accidental bump of the container will cause an acceleration on one or more of the X axis, Y axis or Z axis which exceeds the threshold value for a hostile event. The controller 124 algorithms may discriminate such an event is due to an impulse occurrence such as a bump or knock and allow false alarm conditions to be minimised.

It will be appreciated that the steps described above may be performed in a different order, varied, or omitted entirely without departing from the scope of the present invention.

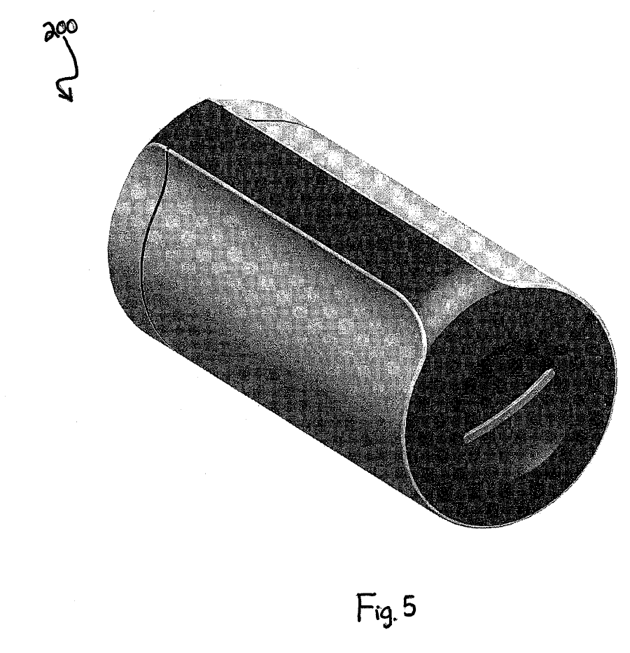

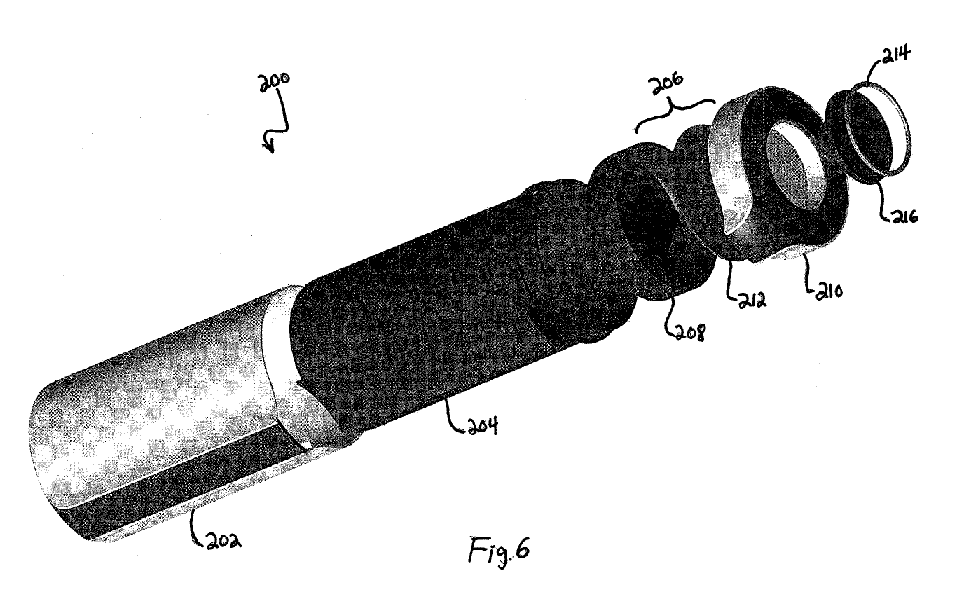

Referring now to FIGS. 5 and 6, a portable alarm unit 200 is shown in accordance with another preferred embodiment of the present invention. Unit 200 is similar to container 100 described above except that unit 200 is preferably configured with a cylindrical external shape. Referring to FIG. 6, unit 200 preferably includes an outer case 202, an inner case 204 and a cap 206. Cap 206 preferably includes a cap bottom 208 and a cap top 210. Cap bottom 208 and cap top 210 are preferably configured to engage one another to trap a controller 212 therebetween. In a preferred embodiment, controller 212 includes a printed circuit board. A grill sealing ring 214 is preferably included to secure piezo alarm 216 to cap top 210.

In use, cap 206 screws onto the top of container 200 with a simple ¼ turn screw thread. Preferably there is a combination lock mounted in the longitudinal rib of the container (not shown) which controls a pin which protrudes through the top rim of container 200. As cap 206 is screwed into place on the top of container 200, the spring actuated pin is depressed. When cap 206 is in place, the pin moves into a hole in the underside rim of cap 206. When the pin is in place, it preferably locks cap 206 from being rotated, which means cap 206 cannot be removed from container 200. The pin is preferably attached to a knob which allows the user to pull the pin down out of cap 206, which then allows cap 206 to be turned and removed, thus opening container 200. If the combination lock is moved to the closed position, the pin is locked into the position where it prevents cap 206 from being rotated, thus preventing container 200 from being opened until the correct combination is set.

Cap 206 preferably contains the same motion detector and alarm system as is used in the lid described above in relation to container 100. Preferably, there is a keypad built around the top rim which serves the same purpose as keypad 132 of container 100.

It will be appreciated that the unit may be configured as a stand-alone unit that is attachable with or insertable into another object. The attachable unit preferably does not have a storage space in order to permit it to be more compact. A connection means such as a loop or key chain may be provided with the unit if desired.

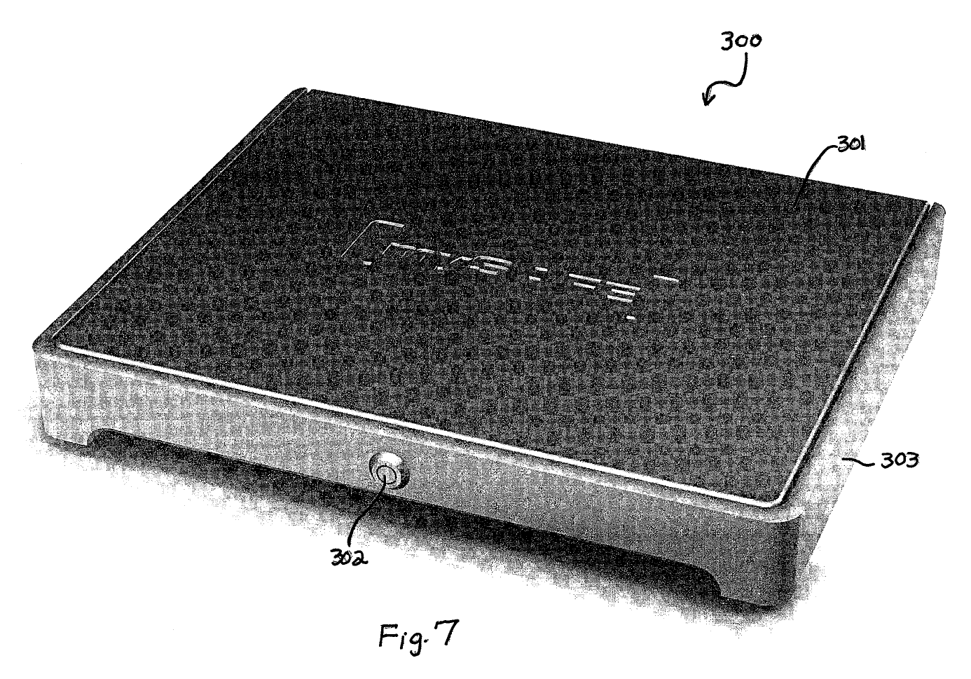

Referring now to FIG. 7, a semi portable container 300 is shown in accordance with another preferred embodiment of the present invention. Unit 300 is similar to container 100 already described except that Unit 300 is preferably configured so that it is able to contain a laptop computer.

Unit 300 preferably includes an outer case constructed of steel which has a protective and decorative dressing 303. The plastic dressing attaches to the outer sides of the steel case, and provides additional strength to the steel case 300.

The plastic dressing 303 also extends into the front of case 300 to provide a protective support. In addition, internal soft dressings which attach to the steel case 300, but not shown, provide protection to the laptop computer.

A hinged lid 301 is held shut by a high security key lock 302 and when closed securely contains a laptop computer inside the container.

The front section of the case 300 preferably contains the same motion detector and alarm system as is used in the lid described above in relation to container 100. Preferably instead of a keypad similar to the keypad 132 of container 100, the motion detector and alarm system of container 300 are activated and de-activated by a key lock 302.

Preferably when hinged lid 301 is open, an Arm/Disarm switch is accessible allowing the motion detector and alarm system to be enabled or disabled. When the Arm/Disarm switch is set to Arm locking the hinged lid 301 of container 300 with key lock 302 activates the motion detector and alarm system. Unlocking the hinged door 301 with key lock 302 deactivates the motion detection and alarm system allowing a laptop computer to be placed inside or removed from container 300. When the Arm/Disarm switch is set to Disarm, the motion detector and alarm system is de-activated, but a laptop computer can still be secured inside container 300 by locking hinged lid 301 with key lock 302.

It can be appreciated that the physical size of container 300 makes it less of a portable device than container 100 or container 200. Being preferably constructed primarily of steel also increases its weight significantly so that it is unlikely container 300 will be used to carry a laptop computer from place to place. It is also apparent that from its physical shape and functional operation that in most cases it will be placed horizontally or vertically.

The foregoing description is by way of example only, and may be varied considerably without departing from the scope of the present invention. For example only, the size, shape, colour, weight and material of the container may be varied as desired. For example, the container may have a storage capacity ranging from zero to that of a standard cargo container (or more). The shape may be configured specifically for items such as laptop computers, mobile phones and MP3 players, and even traditionally non-electrical items such as handguns. When formed for use with a laptop computer, the container and/or system may be sized and configured for substantially enveloping the laptop (see, FIG. 7), or may be of reduced size and configuration so as to cover only a portion of the exterior of the laptop. The system may be incorporated into the laptop if desired. The container may be water-proof if desired (in which case one or more LEDs may be used to provide a visual alarm).

Elements of the movement detection system may be varied. For example, the placement, number, and type of alarms may be varied as desired. Examples of alarms include audio and/or visual and/or wireless to a monitoring base station. A variety of input means may be utilised. For example, the system may include a biometric reader, a magnetic reader such as a swipe card reader, manual push means such as alphanumeric keys or dials, voice activated arming, mechanical switches, mechanical lock and key, radio control, RDFI or any combination thereof.

The power supply may be self-contained and/or derived from an outside source. For example, the power supply may be battery powered with disposable or rechargeable batteries, or utilise another onboard source such as one or more solar panels. Any onboard power supply may be supplemented or replaced by an external source accessible via a power connection (e.g., a cable connection between the container and a wall outlet).

The movement detection system may be configured to measure displacement in only one plane if desired. For example, the system may be configured to measure in only the horizontal plane, or only the vertical plane, or a diagonal plane. The movement detection system may be used to lock the container in addition to or in place of a manual lock between portions of the container. For example, the keypad may be used to insert a combination to release a lock between the lid and base. The system may include one or more global positioning system (GPS) elements in place of or in addition to the accelerometer. One or more components of the system may be remotely located or controlled if desired. For example, the alarm may be separately portable and carried, for example, as a key ring with the user. One or more elements of the movement detection system may be integral with the object which it is desired to protect. For example, products such as car alarms, laptop computers and cell phones may include the movement detection system such as described above as an integral component of their structure. This may involve, for example, configuring the computer electronics of the product to function as described above.

The features described with respect to one embodiment may be applied to other embodiments, or combined with or interchanged with the features other embodiments, as appropriate, without departing from the scope of the present invention.

The present invention in a preferred form provides many advantages. For example only, the dual security of a combination lock and a displacement measuring alarm system provides a high level of security against theft of the valuables protected by the movement detection system. The present invention in a preferred embodiment may discriminate against different types of movement in three dimensional space. The present invention in a preferred embodiment may be adapted to operate in any physical orientation equally well and provide the same level of sensitivity to the measurement of displacement of itself in all orientations. The present invention in a preferred embodiment may be adapted to measure its own acceleration and calculate its own velocity and displacement in three dimensional space (X, Y, and Z axes) relative to an initial reference position in three-dimensional space. The present invention in a preferred embodiment may be adapted to discriminate between motion caused by accidentally bumping and motion caused by the container moving beyond a predetermined three-dimensional distance from an initial resting place. The present invention in a preferred embodiment is not required to be in a predetermined orientation.

The present invention has many applications. For example only, elements of the container and/or system may be used for portable security items such as cargo containers, vehicles such as cars, bicycles, motorcycles, and in environments such as hospitals, schools, prisons, sporting venues, and recreational areas such as beaches and parks. The container and/or system may be sized and configured for use with a handgun if desired. If used with a handgun, the system may also be incorporated with a handgun lock, for example, around the trigger area. The container and/or system may be attached to or incorporated into suitcases, backpacks or other luggage carrying products if desired. As will be appreciated, many other applications are available.

It will of course be realised that the above has been given only by way of illustrative example of the invention and that all such modifications and variations thereto as would be apparent to persons skilled in the art are deemed to fall within the broad scope and ambit of the invention as herein set forth.

What is claimed is:

1. An alarm system, comprising:
a motion detector adapted to measure acceleration;
a controller adapted to calculate displacement of said motion detector from a reference point based at least in part on the acceleration of said motion detector; and
an alarm adapted to transmit a signal when said motion detector has moved beyond a predetermined position from the reference point.

2. The system of claim 1, wherein said controller is adapted to dynamically determine the displacement of said motion detector from the reference point.

3. The system of claim 1, wherein said motion detector includes a MEMS sensor arrangement.

4. The system of claim 1, wherein the predetermined position forms at least a portion of a sphere around the reference point and said controller is adapted to activate said alarm when said motion detector moves beyond the sphere.

5. The system of claim 1, wherein the predetermined position is generally in a single plane containing the reference point.

6. The system of claim 1, wherein said alarm is adapted to transmit a light signal.

7. The system of claim 1, wherein said alarm is adapted to transmit an audio signal.

8. The system of claim 1, wherein said motion detector, said controller and said alarm are physically connected to one another.

9. The system of claim 1, wherein said system is formed as a self-contained unit, further comprising a connector for attaching said unit to an object.

10. The system of claim 1, further comprising a biometric reader adapted to arm said alarm.

11. A container, comprising:
a body having a storage compartment; and
a movement detection system having a motion detector, a controller adapted to calculate displacement of said body from a reference point based at least in part on acceleration of said body, and an alarm adapted to transmit a signal when said body has moved beyond a predetermined position from the reference point.

12. The container of claim 11, wherein said movement detection system is integrally formed with said body.

13. The container of claim 11, further comprising a biometric reader adapted to arm said alarm.

14. A method for alerting a person to movement of an object beyond a preset boundary, comprising:
measuring acceleration of the object from an initial reference point to at least in part determine the displacement of the object from the initial reference point;
comparing the displacement of the object relative to the preset boundary; and
producing a signal if the object crosses the preset boundary.

15. The method of claim 14, wherein the step of measuring includes dynamically measuring the acceleration of the object from the initial reference point.

16. The method of claim 14, further comprising re-setting the boundary.

17. The method of claim 14, wherein the object is a container.

18. The method of claim 14, wherein the preset boundary is at least in part spherical.

19. The method of claim 14, wherein the step of measuring includes measuring generally only along a single plane.

20. The method of claim 14, wherein the step of producing a signal includes producing an audio signal.
